(19) United States
(12) Patent Application Publication
(10) Pub. No.: US 2012/0187146 A1
(43) Pub. Date: Jul. 26, 2012

(54) Hand Sanitizer Dispenser with Informational Display and System Thereof

(76) Inventor: Sameer Chopra, New York, NY (US)

(21) Appl. No.: 13/014,177

(22) Filed: Jan. 26, 2011

(51) Int. Cl. B67D 1/00; B67D 1/07; B67D 7/06

(52) U.S. Cl. 222/52; 222/192; 222/23

(57) ABSTRACT

A hand sanitizer dispenser that automatically dispenses a certain amount of hand sanitizer when a motion and proximity sensor detects the presence of a user's hand. The hand sanitizer dispenser uniquely stores the hand sanitizer in the shaft of the dispenser to strategically use the space within the housing to store a large amount of hand sanitizer while providing a compact and sleek dispenser. The hand sanitizer dispenser is self-contained such that it is portable and can be conveniently placed at any location as the need arises. The hand sanitizer dispenser optionally may include a compact display that displays static or dynamic graphic or information to the user and/or a global positioning system. The display is adjustable to any orientation, tilt or angle to allow the dispenser to fit into all areas and to provide maximum exposure.

### FIELD OF THE INVENTION

The invention relates to a dispenser that dispenses hand sanitizer and a system thereof. In particular, a compact, sleek, and self-contained device that dispenses hand sanitizer, with or without an informational display screen, and a system thereof.

### BACKGROUND OF THE INVENTION

Hand sanitizer is known to be used to disinfect a person's hands when a person does not have access to soap and water to wash his/her hands. While individuals may carry a bottle of hand sanitizer, a person often forgets or is too lazy to retrieve the bottle from his/her pocket or bag to use the hand sanitizer. To encourage disinfecting a person's hands to minimize the spread of germs and diseases, many public areas provide hand sanitizer dispensers. Hand sanitizer dispensers are commonly available in hotels, building lobbies, stadiums, theaters, schools, cafeterias, restaurants, retail stores, hospitals, and other public areas etc.

The most common type of hand sanitizer dispenser is a manually operated pump-type unit that is mounted on a wall. Upon pressing the pump button, a certain amount of hand sanitizer is dispensed. This type of prior art dispenser does not necessarily minimize the spread of germs and diseases because each person using, or trying to use, the dispenser necessarily has to touch the pump button; thereby, allowing the spread of germs and diseases.

To overcome the shortcomings of the prior art dispenser discussed above, there are other wall mounted prior art dispensers that automatically dispense the hand sanitizer by providing a motion and proximity sensor. When a person's hand comes within the purview of the motion and proximity sensor, a certain amount of hand sanitizer is automatically dispensed.

The above prior art dispensers are typically small and mounted to a wall. A major disadvantage of wall mounted dispensers is that a user may overlook the presence of the dispenser or is too lazy to walk out of the way towards a wall to use the hand sanitizer. This defeats the purpose of providing a hand sanitizer dispenser. Further, a wall mounted dispenser cannot be easily re-located to a different location as the needs arise. The small size of the dispenser translates to the limited amount of hand sanitizer storable, which requires more frequent servicing of the dispenser.

Free standing prior art hand sanitizer dispensers are also available. However, they are bulky and unattractive. See U.S. Patent Application Publication No. 2010/0051639, U.S. Pat. Nos. 6,691,897, 7,222,747, D604,974, and D563,705. In order to generate advertising revenues, most of these dispensers intentionally include a bulky display section to attract attention. Some of these dispensers resemble a kiosk and cannot be easily moved or, even if movable, it would interfere with foot traffic unless placed out of the way. Others are bulky on top, which could easily tip over or be bumped by someone passing it. Further, the display section of the prior art dispensers is fixed and is not adjustable to different orientations, angles or tilts, making them difficult to fit into all areas and to attain maximum exposure.

While some of the free standing prior art hand sanitizer dispensers may be moved from one location to another, locating them is a different story. Once a hand sanitizer dispenser is placed at a location, if someone moves it (intentionally or not), locating it can be a problem.

Therefore, there is a need for an improved hand sanitizer dispenser that is compact, sleek, and self-contained that overcome the disadvantages of the prior art hand sanitizer dispensers.

### SUMMARY OF THE INVENTION

The present invention provides a dispenser that is compact, sleek, and self-contained for dispensing hand sanitizer, with or without an informational display screen.

The hand sanitizer dispenser of the present invention automatically dispenses a certain amount of hand sanitizer when the motion and proximity sensor detects the presence of a user's hand. The hand sanitizer dispenser uniquely stores the hand sanitizer in the shaft of the dispenser to strategically use the space within the housing to store a large amount of hand sanitizer while providing a compact and sleek dispenser. The hand sanitizer dispenser is self-contained such that it is portable and can be conveniently placed at any location as the need arises. The hand sanitizer dispenser optionally may include a compact display that displays static or dynamic graphic or information to the user and a global positioning system (“GPS”).

The hand sanitizer dispenser of the present invention comprises a housing including a base portion, a shaft portion extending therefrom, and a dispensing portion at the distal end of the shaft portion. The base portion is set on a flat surface, which houses the power source. The hand sanitizer dispenser may be powered by batteries, solar power or via an AC adaptor, which are housed within the base portion. If solar powered, the upper surface of the base portion may include solar panels to absorb solar energy for conversion to electrical energy. The elongated shaft portion provides a space for storing a bottle of hand sanitizer for dispensing via the dispensing portion. The dispensing portion is located at a height conveniently located at a user's arm's length and includes a motion and proximity sensor. At the top of the shaft portion, at a level within a user's peripheral vision, is an optional display portion that includes a display screen such as an LCD/LED display screen. The display screen can show information that is visually static, such as pictures, or dynamic, such as a video. The display portion may include speakers to provide accompanying audio to the display screen. Data to be displayed on the display screen and played on the speakers may be accessible via a USB port on the housing or wirelessly. The footprints of the dispensing portion and the display portion, at their widest, are each smaller than the footprint of the base portion, at its widest, and not more than four times the footprint of the shaft, at its widest, to provide a compact, sleek dispenser.

### BRIEF DESCRIPTION OF THE DRAWINGS

Preferred embodiments of the present invention have been chosen for purposes of illustration and description and are shown in the accompanying drawings forming a part of the specification wherein:

FIG. 1 is the front perspective view of the hand sanitizer dispenser of the present invention.

FIG. 2 is the rear perspective view of the hand sanitizer dispenser of FIG. 1.

FIG. 3 is the magnified and cross-sectional views of the upper portion of the access panel.

FIG. 4 is the magnified and cross-sectional views of the lower portion of the access panel.

FIG. 5 is the top view of the base.

FIG. 6 is the front perspective view of a second embodiment of the hand sanitizer dispenser of the present invention with an informational display screen.

FIG. 7 is the rear perspective view of the hand sanitizer dispenser of FIG. 6.

FIG. 8 is the simplified cross-sectional and exploded view of the hand sanitizer dispenser of FIG. 6.

FIG. 9 is a block diagram showing a system with a plurality of hand sanitizer dispensers of the present invention.

### DETAILED DESCRIPTION OF THE PREFERRED EMBODIMENTS

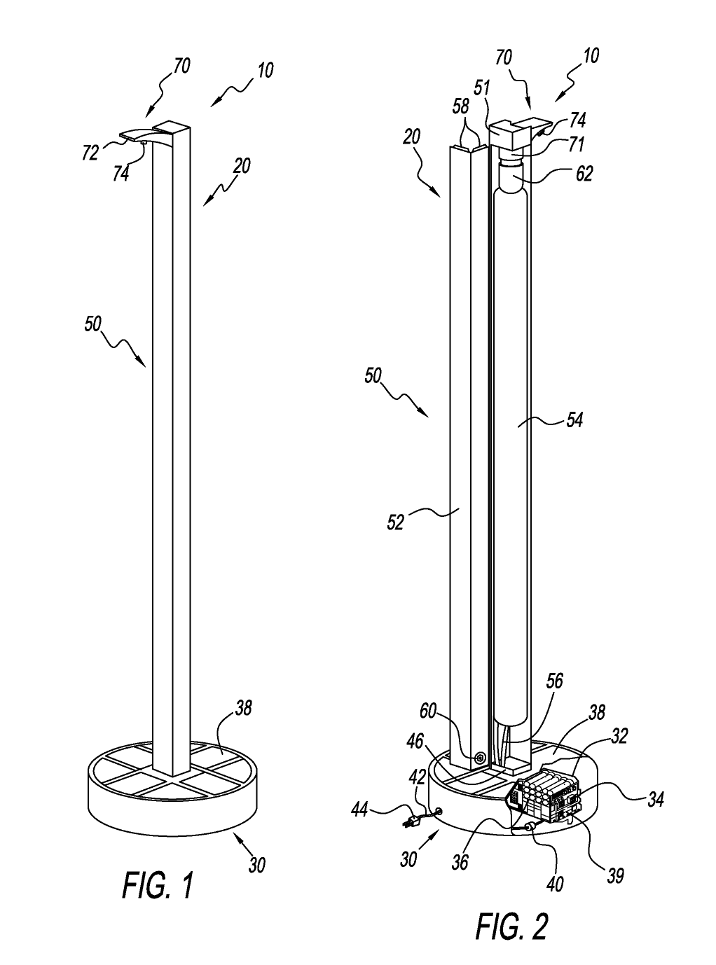

With reference to the drawings, wherein the same reference number indicates the same element throughout, there is shown in FIGS. 1-5 a hand sanitizer dispenser 10 of the present invention. The hand sanitizer dispenser 10 comprises a housing 20 having a base portion 30, a shaft portion 50 extending therefrom, and a dispensing portion 70 at the distal end of the shaft portion 50.

The base portion 30 of housing 20 houses most of the components of the dispenser 10, including the power source 32 and electrical circuitry 34. The hand sanitizer dispenser 10 may be powered by batteries 36, solar power, via an AC adaptor 40 plugged to a wall outlet or a combination of two or more of these sources. The electrical circuitry 34 may include a printed circuit board that controls various electrical functions of the dispenser 10, a wireless modem, a universal serial bus (“USB”) port (or other types of interface port), a global positioning system (“GPS”), and/or a data storage device (such as flash, RAM, ROM, hard drive, etc.). Preferably the base portion 30 has a disk shape for setting the dispenser 10 on a flat surface, whether on the floor or on a raised surface such as a table.

For a hand sanitizer dispenser 10 powered by batteries, base portion 30 has a compartment for receiving the batteries 36. The batteries 36 may be regular or re-chargeable batteries.

For a hand sanitizer dispenser 10 powered by solar power, one or more solar panels 38 are provided on the upper surface of the base portion 30. The solar panels 38 absorb solar energy and a converter 39 located in the base portion 30 converts it into electrical energy.

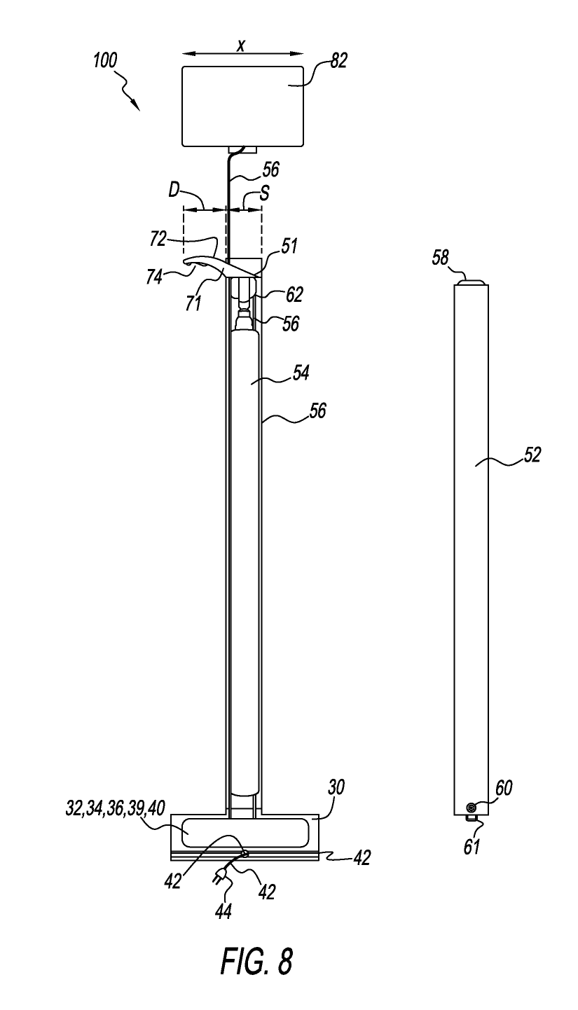

For a hand sanitizer dispenser 10 powered via an AC adaptor 40 plugged to a wall outlet, the AC adaptor 40 is located in the base portion 30. The AC adaptor 40 has a retractable cord 42 with a plug 44 for mating with a wall outlet. The retractable cord 42 preferably is coiled around and stored inside the circumference of the base portion 30 (see FIG. 8). The AC adaptor 40 not only can be used to solely power the hand sanitizer dispenser 10, but it can also be used for charging the re-chargeable batteries 36 or to supplement the solar power when there is not enough solar energy.

The shaft portion 50 of housing 20 extends vertically from the base portion 30, preferably but not necessarily, from the center of the base portion 30. The shaft portion 50 provides a space for storing a bottle of hand sanitizer 54 that takes up substantially the entire length and space therein. Other than the storage of the bottle of hand sanitizer 54, the space within the shaft portion 50 allows wires 56 to travel from the base portion 30 to the dispensing portion 70 and beyond.

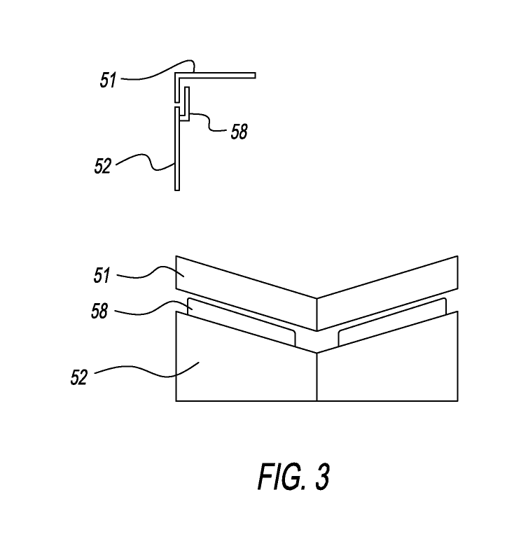

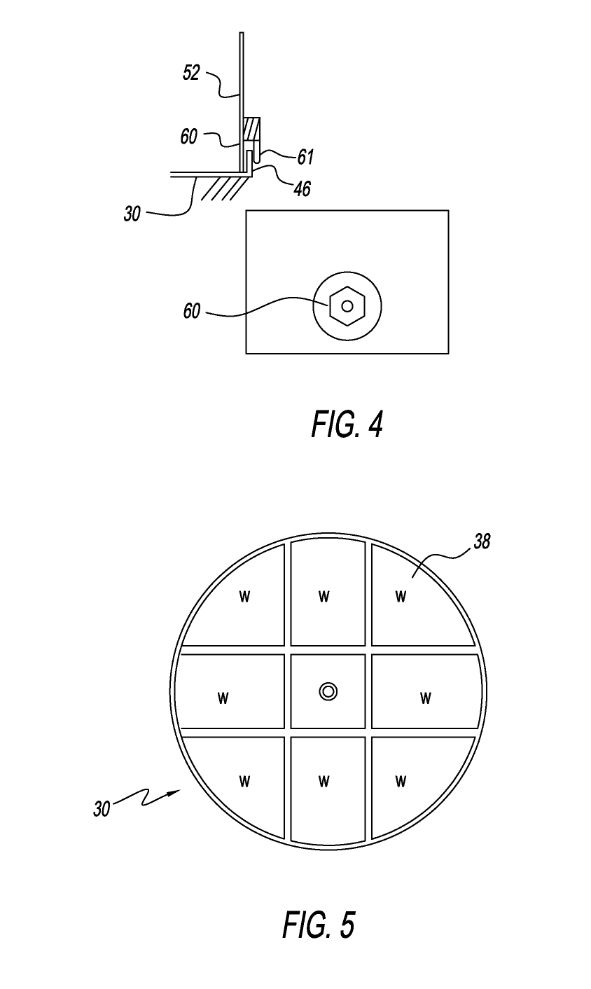

The shaft portion 50 includes an elongated housing 51 and an access panel 52 that extends substantially the length of the elongated housing 51 so that the bottle of hand sanitizer 54 can be easily accessed and replaced. The upper portion of the access panel 52 has one or more tabs 58 that mate with the upper portion of the elongated housing 51 to provide a smooth, flushed interface between the access panel 52 and the elongated housing 51 (see FIG. 3). When the access panel 52 mates with the elongated housing 51, the lower portion of the access panel 52 abuts and sits on the upper surface of the base portion 30. Near the lower portion of the access panel 52 is a locking mechanism 60 that interacts with a raised wall 46 extending from the upper surface of the base portion 30 (see FIG. 4). Locking mechanism 60 has a unique screw head that allows a special electronic key to turn the locking tab 61 to selectively interact with the raised wall 46 to lock or unlock the access panel 52 with respect to the elongated housing 51.

An electronic pump unit 62 is attached to the top of the bottle of hand sanitizer 54 and is also housed within the shaft portion 50 of housing 20. Alternatively, the pump unit 62 may be attached to the bottom of the bottle of sanitizer 54. The pump unit 62 withdraws a certain amount of hand sanitizer from the bottle of hand sanitizer 54 to be dispensed through the dispensing portion 70 via at least one delivering tube 71. Power for the pump unit 62 is provided by the power source located in the base portion 30 of the housing 20 via wires 56.

The dispensing portion 70 of housing 20 is located at the distal end of the shaft portion 50, at a height conveniently located at a user's arm's length. The dispensing portion 70 includes a dispensing spout 72 and a motion and proximity sensor 74. Power for the motion and proximity sensor 74 is provided by the power source located in the base portion 30 of the housing 20 via wires 56. When the motion and proximity sensor 74 detects the presence of a user's hand within the purview of the sensor 74, it sends an electronic signal to the pump unit 62 to dispense a certain amount of hand sanitizer to the user via the dispensing spout 72 and delivering tube 71. The angle (360° rotatable around the vertical axis) and tilt (˜90° pivotable along the horizontal axis) of the dispensing spout 72 may be adjustable as desired by mounting the dispensing spout 72 on a ball and socket joint or similar types of connection known to one skilled in the art. To maintain a compact and sleek dispenser 10, the footprint of the dispensing portion 70, at its widest (distance D in FIG. 8), does not extend more than two or two-and-a-half times the footprint of the shaft portion 50, at its widest (distance S in FIG. 8). The motion and proximity sensor 74, in the alternative, may be positioned at another location on the housing 20, such as the shaft portion 50, the base portion 30 or the display portion 80 (to be described below).

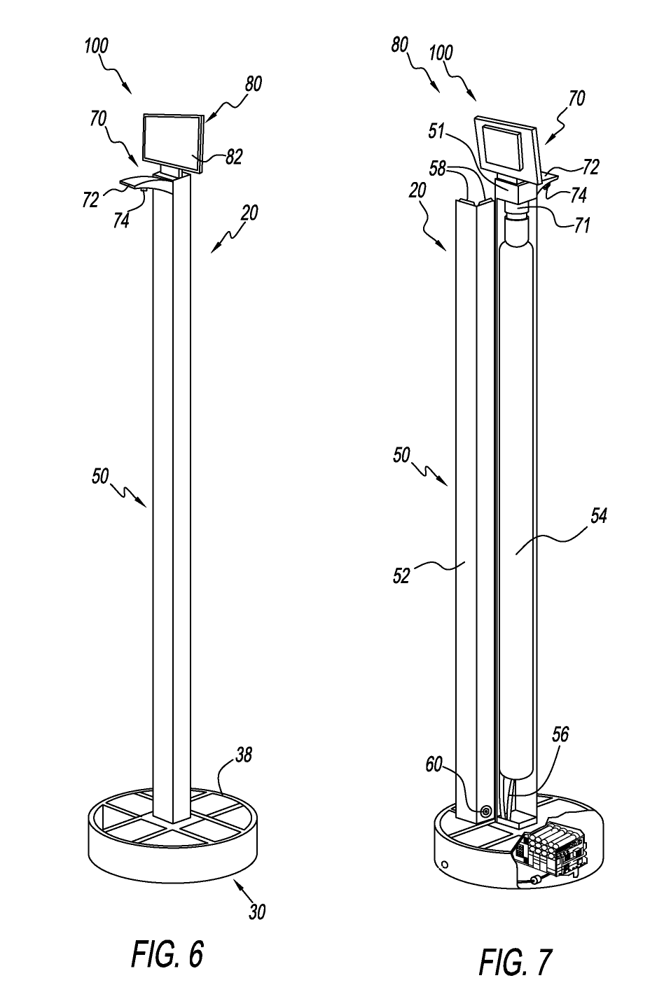

FIGS. 6-8 show a second embodiment of the hand sanitizer dispenser 100 of the present invention. The hand sanitizer dispenser 100 is the same as the hand sanitizer dispenser 10 of FIGS. 1-5, except that it includes a display portion 80. The display portion 80 is located at the top of the shaft portion 50 at a level within a user's peripheral vision. The display portion 80 includes a display screen 82. The display screen 82 can be a LCD display screen, a LED display screen, an Apple Inc.'s iPad device or similar devices. If a LCD/LED display screen is used, the electronic circuitry 34 that controls and stores data for the display screen 82 may be located at the base portion 30 of housing 20. Power to the display screen 82 is provided by the power source located also in the base portion 30 of housing 20 via wires 56. To maintain a compact and sleek dispenser 100, the footprint of the display screen 82, at its widest (distance X in FIG. 8), does not extend more than four times the footprint of the shaft portion 50, at its widest (distance S in FIG. 8). Different size display screens 82 can be used. The orientation (portrait versus landscape), angle (360° rotatable around the vertical axis), and tilt (−180° pivotable along the horizontal axis) of the display screen 82 may be adjustable as desired by mounting the display screen 82 or the display portion 80 on a ball and socket joint or similar types of connection known to one skilled in the art to attain maximum exposure. The display screen 82 can also be mounted on a motor to allow it to automatically rotate for even more exposure. The display screen 82 can be turned on at all time, or selectively at certain time. Alternatively, to conserve power, the display screen 82 can be turned on only when the motion and proximity sensor 74 detects the presence of a user sufficiently close enough to view the display screen 82 although not necessarily close enough to receive the hand sanitizer.

The display screen 82 can show information that is visually static, such as pictures, slide shows, posters or flyers. The display screen 82 can also show information that is visually dynamic, such as a video (2D or 3D). The display portion 80 may include speakers to provide accompanying audio to the content shown on the display screen 82. The following types of content may be shown on the display screen 82—advertisements, infomercials, information, interactive information, maps, directories, announcements, notices, games, movies, etc. The data to be displayed on the display screen 82 and audio to be played on the speakers may be continuously or periodically fed and updated via a wireless modem or USB port. The display screen 82 may have its own wireless modem or USB port or the display screen 82 can, via wires 56, be connected to a wireless modem or USB port located in the base portion 30 of the housing 20.

The hand sanitizer dispenser 10 or 100 may optionally include a global positioning system (“GPS”). A GPS chip may be located in any portion of the housing 20 for optimal functionality. The GPS of the present invention includes supplemental positioning system such that it can function at both indoor and outdoor locations. Any known supplemental positioning system, such as cell site triangulation, may be incorporated into the hand sanitizer dispenser 10 or 100. With the GPS connected to the electrical circuitry 34, information on the locations of the hand sanitizer dispenser 10 or 100 can be stored and/or transmitted via the wireless modem and/or USB port.

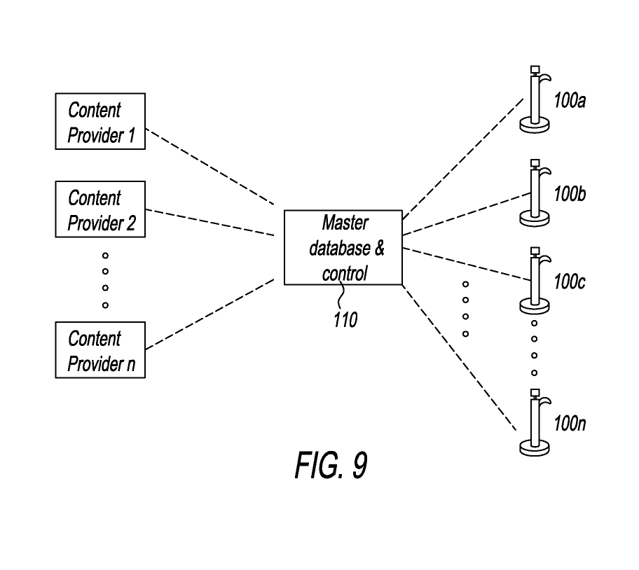

Location of the hand sanitizer dispenser 10 or 100 is important not only to locate the dispenser itself due to the portability of the dispenser 10 or 100, but also to provide market information to advertisers and other content providers. For example, a content provider can obtain or confirm its target audience by knowing where each dispenser 10 or 100 displaying its content is located. Such information can be continuously transmitted via a wireless modem or USB port to the content provider or periodically transmitted by first storing such information in the data storage device in the dispenser 10 or 100. FIG. 9 illustrates the system using a plurality of hand sanitizer dispensers 100a to 100n, with each transmitting its respective information to a master database and control 110, via any means known to one skilled in the art, such as via the wireless modem or USB port. Each content provider (1 to n) can have password protected access to the master database and control 110 to obtain information on each hand sanitizer dispenser 100 that displays its content. The master database and control 100 may be a website available to be accessed by the content providers on the internet. The master database and control 110 may be continuously or periodically updated.

The electrical circuitry 34 of the hand sanitizer dispenser 10 or 100 may also monitor and keep track of the usage of the hand sanitizer dispenser 10 or 100. Such usage information can similarly be transmitted to the master database and control 110 via the wireless modem or USB port. The master database and control 110 may be a computer or server at a remote location. Such usage information can indicate when the hand sanitizer bottle 54 is in need of refill or replacement, whether the dispenser has malfunctioned, and the frequency of usage. The frequency of usage of the hand sanitizer dispenser 100 has a direct correlation as to the frequency of viewing of the display screen 82 by a user because a user must be closed enough to the dispensing spout 72 to receive the hand sanitizer, and hence, would be closed enough to view the display screen 82. Combining the usage and location information, the hand sanitizer dispensers 100 can be strategically placed in a high usage area for maximum exposure of information displayed on the display screen 82. As discussed in connection with FIG. 9, a content provider similarly has an interest in receiving information on the frequency of usage of each dispenser 10 or 100.

The two main features of the hand sanitizer dispenser 100, the dispensing portion 70 and the display portion 80, advantageously complement each other by attracting a user both ways. If a user was first attracted by the display portion 80, the user then get to use the hand sanitizer. On the other hand, if a user was first attracted by the hand sanitizer from the dispensing portion 70, the user will also be exposed to the content shown on the display portion 80.

Some of the components described above in connection with the hand sanitizer dispenser 100 can be eliminated if an Apple Inc.'s iPad or similar devices is used as the display screen 82 because such devices would have built-in GPS, wireless modem, electrical circuitry, cellular technology, USB or other interface port, etc.

The features of the invention illustrated and described herein are the preferred embodiments. Therefore, it is understood that the appended claims are intended to cover the variations disclosed and unforeseeable embodiments with insubstantial differences that are within the spirit of the claims.

What I claim is:

1. A device for dispensing hand sanitizer comprising:
a. a housing having a base portion, an elongated shaft portion extending from said base portion, and a dispensing portion at the distal end of the said shaft portion, wherein said dispensing portion having a dispensing spout;
b. a motion and proximity sensor on said housing;
c. a bottle of hand sanitizer stored within said shaft portion;
d. a pump unit within said housing for extracting the hand sanitizer from said bottle;
e. means for delivering the hand sanitizer from said pump unit to said dispensing spout and
f. a power source located in said housing providing power to said motion and proximity sensor and said pump unit via at least one wire;
wherein upon said motion and proximity sensor detecting the presence of a user's hand, said pump unit extracts a certain amount of hand sanitizer from said bottle for dispensing via said delivering means to said dispensing spout.

2. The device of claim 1 wherein the widest dimension on a horizontal plane of said dispensing portion is less than two times the widest dimension on a horizontal plane of said shaft portion.

3. The device of claim 1 wherein the widest dimension on a horizontal plane of said dispensing portion is less than two and a half times the widest dimension on a horizontal plane of said shaft portion.

4. The device of claim 1 further comprising a display portion at the top of said shall portion wherein said display portion comprises a display screen powered by said power source via at least one wire.

5. The device of claim 4 wherein said display portion further comprises at least one speaker powered by said power source via at least one wire.

6. The device of claim 1 further comprising electronic circuitry within said housing powered by said power source via at least one wire that monitors and keeps track of the usage of said device.

7. The device of claim 1 wherein said power source comprises batteries.

8. The device of claim 1 wherein said power source comprises at least one solar panel and a converter for converting solar energy.

9. The device of claim 1 wherein said power source comprises an AC adaptor, a plug and a length of electrical cord retractably stored within said base portion connecting said AC adaptor to said plug.

10. The device of claim 1 further comprising a global positioning system within said housing and powered by said power source that provides the location of said device.

11. The device of claim 1 further comprising an iPad device at the top of said shaft portion.

12. The device of claim 4 further comprising an interface port within said housing for importing data for said display screen.

13. The device of claim 6 further comprising an interface port within said housing for exporting said usage data of said device to a remote location.

14. The device of claim 4 further comprising a wireless modem within said housing and powered by said power source for receiving data for said display screen.

15. The device of claim 6 further comprising a wireless modem within said housing and powered by said power source for transmitting said usage data of said device to a remote location.

16. The device of claim 4 further comprising a data storage device for storing data for said display screen.

17. The device of claim 6 further comprising a data storage device for storing said usage data.

18. The device of claim 1 wherein said bottle is sized to be substantially the entire length and space of said shaft portion.

19. The device of claim 1 wherein said shaft portion having a removable access panel to provide access to the space within said shaft portion.

20. The device of claim 19 further comprising means for locking said access panel to said shaft portion to enclose the space within said shaft portion.

21. The device of claim 4 wherein said display portion further comprises means for positioning said display portion in any orientation, angle and tilt.

22. The device of claim 1 wherein the widest dimension on a horizontal plane of said display portion is less than four times the widest dimension on a horizontal plane of said shaft portion.

23. The device of claim 4 wherein said display portion is powered on upon said motion and proximity sensor detecting the presence of a user nearby.

24. The device of claim 10 wherein said global positioning system further comprises a supplemental positioning system using cell site triangulation.

25. The device of claim 1 further comprises means for positioning said dispensing portion in any angle and tilt.

26. A system for a content provider to monitor information for a plurality of hand sanitizer dispensers that display the content provider's content, comprising:
a. a master database and control having means for storing information for the plurality of hand sanitizer dispensers;
b. a plurality of hand sanitizer dispenser, each dispenser comprises:
i. a housing having a base portion, an elongated shaft portion extending from said base portion, and a dispensing portion at the distal end of the said shaft portion, said dispensing portion having a dispensing spout;
ii. a motion and proximity sensor on said housing;
iii. a bottle of hand sanitizer stored within said shaft portion;
iv. a pump unit within said housing for extracting the hand sanitizer from said bottle;
v. means for delivering the hand sanitizer from said pump unit to said dispensing spout;
vi. a display portion at the top of said shaft portion wherein said display portion comprises a display screen for displaying the content provider's content;
vii. a global positioning system within said housing that provides information on the location of said dispenser;
viii. means for communicating said information for said dispenser to said master database and control;
ix. a power source located in said housing providing power to said motion and proximity sensor, said pump unit, said display screen, and said global positioning system, via at least one wire;
wherein upon said motion and proximity sensor detecting the presence of a user's hand, said pump unit extracts a certain amount of hand sanitizer from said bottle for dispensing via said delivering means to said dispensing spout;
c. means for accessing said storing means of said master database and control by said content provider to view the information for each dispenser.

27. The system of claim 26 wherein said dispenser further comprises electronic circuitry within said housing powered by said power source via at least one wire that monitors and provides information on the usage of said dispenser such that said content provider may also view such usage information in said storing means of said master database and control via said accessing means.
